(19) United States
(12) Patent Application Publication
(10) Pub. No.: US 2026/0274197 A1
(43) Pub. Date: Sep. 17, 2026

(54) VEHICLE

(71) Applicant: SUBARU CORPORATION, Tokyo (JP)

(72) Inventor: Shinya INOUE, Tokyo (JP)

(21) Appl. No.: 19/549,459

(22) Filed: Feb. 25, 2026

(30) Foreign Application Priority Data
Mar. 17, 2025 (JP) 2025-042982

(51) Int. Cl. B60R 22/14; B60R 22/195; B60R 22/18

(52) U.S. Cl. CPC B60R 22/14; B60R 22/195; B60R 2022/1818

(57) ABSTRACT

A vehicle includes a rear seat, a trim provided obliquely behind the rear seat, a shoulder belt for the rear seat, and a retractor. The retractor is provided in the trim and configured to retract the shoulder belt. The trim has an outlet that is a slit-shaped opening extending along an upper surface of the trim. The outlet allows the shoulder belt to be pulled out of the trim. The trim has recesses in the upper surface of the trim at positions adjacent to the outlet. The recesses are arranged at intervals in a front-rear direction of the vehicle. The shoulder belt is configured such that, when the vehicle collides, a portion of the shoulder belt that is in contact with the upper surface of the trim is guided into and retained by one of the recesses.

### CROSS-REFERENCE TO RELATED APPLICATIONS

The present application claims priority from Japanese Patent Application No. 2025-042982 filed on Mar. 17, 2025, the entire contents of which are hereby incorporated by reference.

### BACKGROUND

The disclosure relates to a vehicle.

To improve the safety of occupants of various body sizes, such as children and adults, a vehicle has been proposed that includes, above a rear seat, a guide device for guiding a shoulder belt of a seat belt apparatus.

For example, Japanese Unexamined Patent Application Publication (JP-A) No. 2002-2443 discloses a guide device including a guide member through which a shoulder belt extends and that is capable of reciprocating in a front-rear direction of a seatback.

### SUMMARY

An aspect of the disclosure provides a vehicle including a rear seat, a trim provided obliquely behind the rear seat, a shoulder belt for the rear seat, and a retractor. The retractor is provided in the trim and configured to retract the shoulder belt. The trim has an outlet that is a slit-shaped opening extending along an upper surface of the trim. The outlet allows the shoulder belt to be pulled out of the trim. The trim has recesses in the upper surface of the trim at positions adjacent to the outlet. The recesses are arranged at intervals in a front-rear direction of the vehicle. The shoulder belt is configured such that, when the vehicle collides, a portion of the shoulder belt that is in contact with the upper surface of the trim is guided into and retained by one of the recesses.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating the structure of a vehicle according to an embodiment of the disclosure;

FIG. 2 is a first diagram illustrating displacements of a shoulder belt through an outlet according to the embodiment;

FIG. 3 is a second diagram illustrating displacements of the shoulder belt through the outlet according to the embodiment;

FIG. 4 illustrates a retaining device according to the embodiment;

FIG. 5 is an enlarged partial view of FIG. 4; and

FIG. 6 illustrates the shoulder belt retained by the retaining device according to the embodiment.

### DETAILED DESCRIPTION

In a vehicle in which the guide position of a shoulder belt is changeable in the front-rear direction of the vehicle as described in JP-A No. 2002-2443, the guide position may be changed in accordance with the occupant's body size to appropriately adjust the position in which the shoulder belt is fastened.

However, according to this technology, when the vehicle collides and the occupant moves forward, the guide position of the shoulder belt also moves forward together with the occupant. As a result, the fastened position of the shoulder belt will be displaced from the appropriate position for the occupant's body size, causing a reduction in the occupant restraint performance of the shoulder belt.

It is desirable to provide a vehicle capable of reducing or preventing the reduction in the occupant restraint performance of the shoulder belt during a vehicle collision.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Vehicle Structure

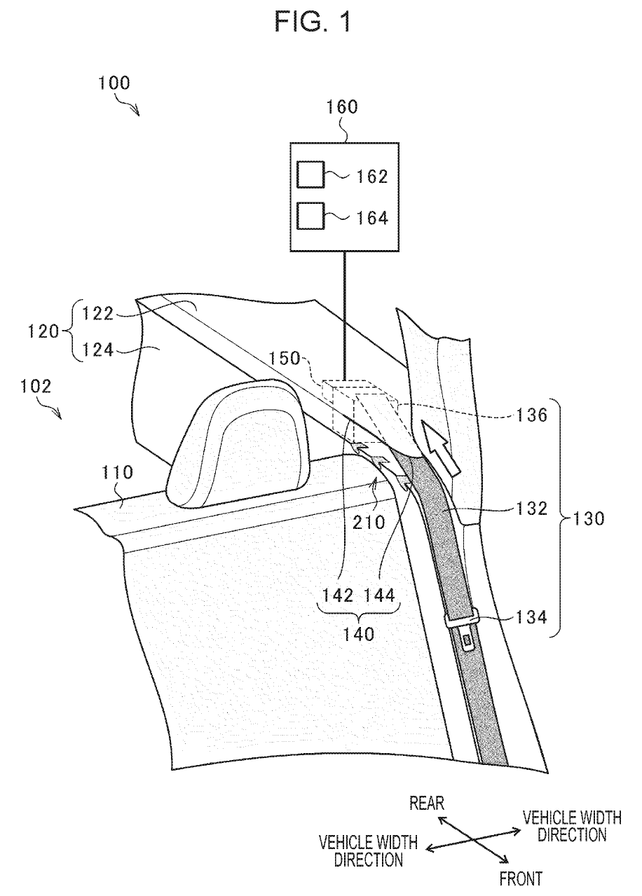

The structure of a vehicle 100 according to the embodiment of the disclosure will now be described with reference to FIGS. 1-3. FIG. 1 is a schematic diagram illustrating the structure of the vehicle 100 according to the embodiment of the disclosure. As illustrated in FIG. 1, the vehicle 100 includes, for example, a rear seat 110, a trim 120, a seat belt apparatus 130, an outlet 140, a pretensioner 150, and a controller 160.

The rear seat 110 is provided in an interior space 102 of the vehicle 100. The rear seat 110 is disposed in a rear region of the interior space 102. The rear seat 110 is, for example, disposed behind a driver's seat and a front passenger's seat. Referring to FIG. 1, the rear seat 110 provided on the left side of the interior space 102 will be described as an example.

The trim 120 is provided obliquely behind the rear seat 110. The trim 120 forms part of a side wall of the vehicle 100. The trim 120 is also referred to as an apron trim. In FIG. 1, the trim 120 is disposed to the left rear of the rear seat 110. In the present embodiment, the trim 120 includes an upper surface 122 and a side surface 124. The upper surface 122 is a surface extending horizontally or substantially horizontally. The side surface 124 is a surface extending vertically or substantially vertically.

The seat belt apparatus 130 includes a shoulder belt 132, a tongue 134, and a retractor 136.

The shoulder belt 132 is formed of a strip-shaped cloth member. The shoulder belt 132 restrains the upper body of an occupant seated in the rear seat 110.

The tongue 134 is slidably attached to the shoulder belt 132. The tongue 134 can be secured to a buckle (not illustrated) disposed on the inner side of the rear seat 110 in a vehicle width direction. The tongue 134 is secured to the vehicle body by being inserted into the buckle.

The retractor 136 retracts one end of the shoulder belt 132. The retractor 136 is provided in the trim 120. The retractor 136 is, for example, disposed closer to the outside than the side surface 124 of the trim 120 and below the upper surface 122 of the trim 120. The end of the shoulder belt 132 is coupled to the retractor 136.

The outlet 140 is provided to allow the shoulder belt 132 to be pulled out from the inner space of the trim 120 into the interior space 102. The outlet 140 is a slit-shaped opening that extends along the upper surface 122 of the trim 120. In the present embodiment, the outlet 140 is formed in the upper surface 122 of the trim 120. Accordingly, the outlet 140 is disposed above the retractor 136.

In the present embodiment, the outlet 140 includes a straight portion 142 and a curved portion 144. The straight portion 142 extends in the front-rear direction of the vehicle 100 and is inclined vertically downward toward the front of the vehicle 100. The curved portion 144 is in front of and continuous with the straight portion 142. The curved portion 144 extends in the vehicle width direction, and is curved to project toward the front of the vehicle 100. The curved portion 144 is inclined vertically downward toward the front of the vehicle 100.

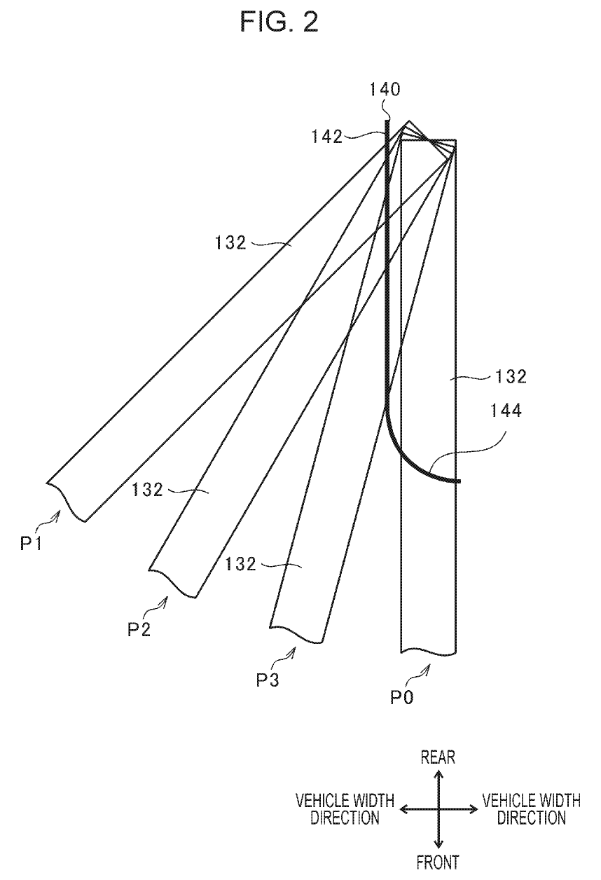

FIGS. 2 and 3 illustrate displacements of the shoulder belt 132 through the outlet 140 according to the present embodiment. FIG. 2 illustrates the outlet 140 as viewed from above the upper surface.

Referring to FIGS. 2 and 3, when no occupant is seated in the rear seat 110, the shoulder belt 132 is disposed to extend into the interior space 102 through the curved portion 144 of the outlet 140. This position of the shoulder belt 132 in the outlet 140 is referred to as an initial position P0.

When an occupant sits in the rear seat 110, the shoulder belt 132 is pulled out into the interior space 102 through the straight portion 142 of the outlet 140. For example, when an occupant having a large body size sits in the rear seat 110, the position of the shoulder belt 132 in the outlet 140 changes from the initial position P0 on the curved portion 144 to a position P1 on the straight portion 142.

When an occupant having an average body size is seated in the rear seat 110, the contact position of the shoulder belt 132 with the occupant's shoulder is below the contact position for an occupant having a large body size. Accordingly, when an occupant having an average body size is seated in the rear seat 110, the position P2 of the shoulder belt 132 on the straight portion 142 is closer to the front of the vehicle 100 than the position P1.

Similarly, when an occupant having a small body size is seated in the rear seat 110, the contact position of the shoulder belt 132 with the occupant's shoulder is below the contact position for an occupant having an average body size. Accordingly, when an occupant having a small body size is seated in the rear seat 110, the position P3 of the shoulder belt 132 on the straight portion 142 is closer to the front of the vehicle 100 than the position P2.

As described above, since the outlet 140 includes the straight portion 142, the position of the shoulder belt 132 in the outlet 140 can be shifted toward the front of the vehicle 100 as the height of the occupant's shoulder decreases. Thus, in the vehicle 100 according to the present embodiment, the fastened position of the shoulder belt 132 can be appropriately adjusted in accordance with the occupant's body size.

The outlet 140 according to the present embodiment includes the curved portion 144. Accordingly, the shoulder belt 132 can be disposed outside the rear seat 110 when no occupant is seated in the rear seat 110. Thus, the occupant can be appropriately seated in the rear seat 110.

Referring to FIG. 1 again, the pretensioner 150 is included in the retractor 136. When a collision of the vehicle 100 is detected, the pretensioner 150 operates the retractor 136 to retract the shoulder belt 132. The pretensioner 150 includes, for example, an explosive charge, which is ignited to generate gas pressure that acts on the retractor 136 so that the shoulder belt 132 is instantaneously retracted in the direction indicated by the hollow arrow in FIG. 1. Here, the term "instantaneously" refers to, for example, a period of several tens of milliseconds.

The controller 160 includes one or more processors 162 and one or more memories 164 coupled to the processors 162. The processors 162 include, for example, a central processing unit (CPU). The memories 164 include, for example, a read-only memory (ROM) and a random access memory (RAM). The ROM is a storage element that stores programs and calculation parameters used by the CPU. The RAM is a storage element that temporarily stores data, such as variables and parameters, used in processes executed by the CPU. The processors 162 of the controller 160 execute the programs stored in the memories 164 to perform various processes related to the controller 160.

The controller 160 detects a collision of the vehicle 100. For example, the controller 160 detects a collision of the vehicle 100 based on a detection value of an acceleration sensor (not illustrated).

When the controller 160 detects a collision of the vehicle 100, the controller 160 activates the pretensioner 150.

As described above, the outlet 140 of the vehicle 100 according to the present embodiment includes the straight portion 142 that extends in the front-rear direction of the vehicle 100. Thus, in the vehicle 100 according to the present embodiment, the fastened position of the shoulder belt 132 can be appropriately adjusted for occupants of various body sizes, including children and adults. As a result, the vehicle 100 of the present embodiment can improve the safety of the occupant regardless of the occupant's body size through the restraint performance of the shoulder belt 132.

When the vehicle 100 collides and the occupant moves forward, the position of the shoulder belt 132 in the outlet 140 also moves forward together with the occupant. As a result, there is a possibility that the fastened position of the shoulder belt will be displaced from the appropriate position for the occupant's body size, causing a reduction in the occupant restraint performance of the shoulder belt.

Accordingly, the vehicle 100 of the present embodiment includes a retaining device 210 that retains the shoulder belt 132 when the vehicle 100 collides. The retaining device 210 will be described in detail below.

### 2. Structure of Retaining Device

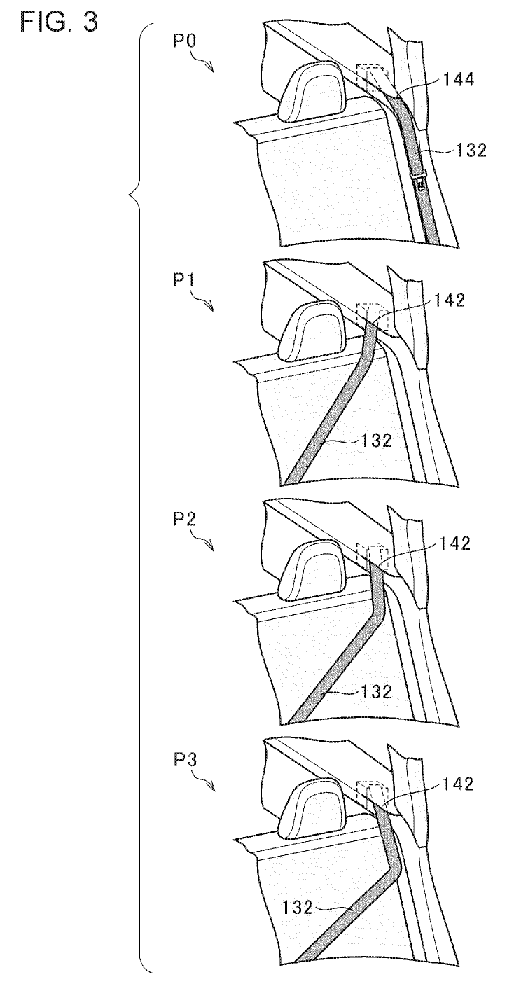

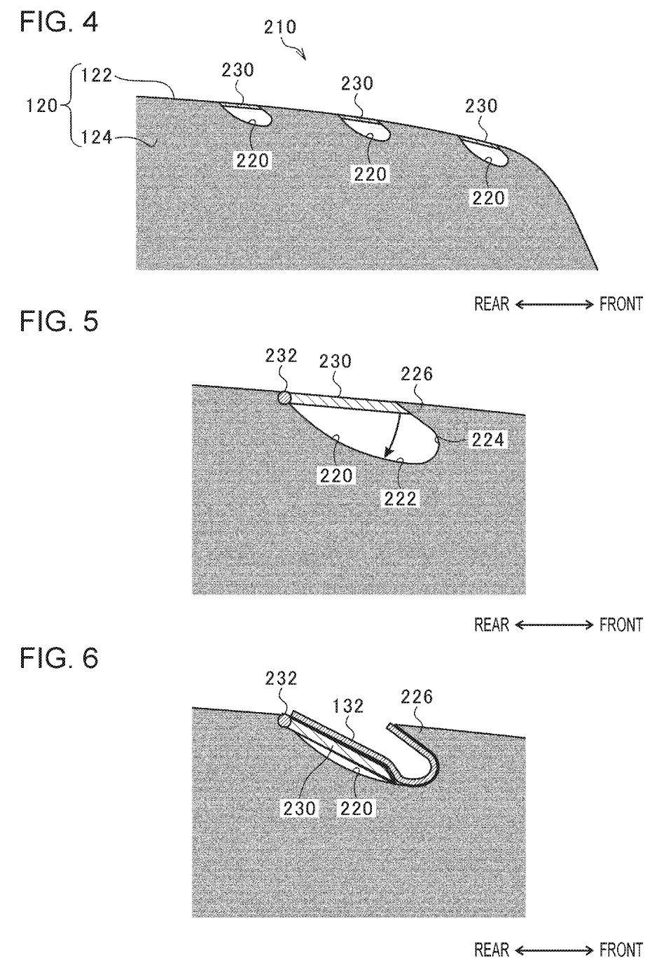

The structure of the retaining device 210 according to the present embodiment will be described with reference to FIGS. 4-6. FIG. 4 illustrates the retaining device 210 according to the present embodiment. FIG. 4 illustrates a side surface 124 of the trim 120. FIG. 5 is an enlarged partial view of FIG. 4. FIG. 6 illustrates the shoulder belt 132 retained by the retaining device 210 according to the present embodiment.

As illustrated in FIG. 4, the retaining device 210 according to the present embodiment includes recesses 220 and lids 230.

The recesses 220 are provided in the upper surface 122 of the trim 120 at positions adjacent to the outlet 140, and are arranged at intervals in the front-rear direction of the vehicle 100. In the present embodiment, the recesses 220 are disposed below the outlet 140. In addition, in the present embodiment, the recesses 220 are notches formed to open in the upper surface 122 and the side surface 124 of the trim 120.

As illustrated in FIG. 5, each recess 220 according to the present embodiment is a U-shaped recess having a recess bottom 222 that is offset forward. A turnover member 226 that projects toward a center of the U-shaped recess is formed on a recess side surface 224 at a front end of the U-shaped recess.

The lids 230 cover the respective recesses 220. The lids 230, for example, cover the recesses 220 to be flush with the upper surface 122 of the trim 120. In the present embodiment, when an occupant is seated in the rear seat 110 and when the vehicle 100 is not in a collision, that is, under normal conditions, the shoulder belt 132 is positioned above the lids 230 that cover the recesses 220. For example, under normal conditions, a portion of the shoulder belt 132 in contact with the upper surface 122 of the trim 120 slides along the upper surface 122 of the trim 120 and the upper surfaces of the lids 230.

One or more of the lids 230 open when the vehicle 100 collides. For example, the lids 230 are openable when the pretensioner 150 is activated. As a result, the recesses 220 may be exposed and the portion of the shoulder belt 132 that is in contact with the upper surface 122 of the trim 120 is guided into and retained by one of the recesses 220.

As described above, when the vehicle 100 collides and the occupant moves forward, the position of the shoulder belt 132 in the outlet 140 also moves forward together with the occupant. Accordingly, when the vehicle 100 collides, the shoulder belt 132 is guided into and retained by one of the recesses 220 that is in front of and closest to the shoulder belt 132. As a result, the movement of the shoulder belt 132 in the front-rear direction is restricted.

For example, when the pretensioner 150 is activated, the shoulder belt 132 retracted by the pretensioner 150 may press downward and open one of the lids 230. As described above, in the present embodiment, the pretensioner 150 operates the retractor 136 to retract the shoulder belt 132. The retractor 136 is disposed below the upper surface 122 of the trim 120. Accordingly, the shoulder belt 132 retracted by the pretensioner 150 receives a force in a direction for pressing the upper surface 122 of the trim 120 downward. Thus, the shoulder belt 132 retracted by the pretensioner 150 presses one of the lids 230 provided on the upper surface 122 of the trim 120 downward.

Referring to FIG. 5, for example, when the lid 230 is provided with a rotating shaft 232 at the rear end thereof, the shoulder belt 132 presses the lid 230 downward so that the front end of the lid 230 rotates downward about the rotating shaft 232, as indicated by the arrow in FIG. 5.

As a result, the recess 220 is exposed and, as illustrated in FIG. 6, the shoulder belt 132 is guided into the recess 220. As described above, the recess 220 is a U-shaped recess. Therefore, when the shoulder belt 132 is guided into the recess 220, the shoulder belt 132 is unlikely to be unnecessarily folded or jammed in the recess 220. In addition, since the turnover member 226 is provided, the shoulder belt 132 retained by the recess 220 is unlikely to be released from the recess 220.

### 3. Effects of Vehicle

The vehicle 100 according to the embodiment of the disclosure has been described.

The vehicle 100 according to the present embodiment includes the rear seat 110, the trim 120 provided obliquely behind the rear seat 110, the shoulder belt 132 for the rear seat 110, and the retractor 136 provided in the trim 120 and configured to retract the shoulder belt 132. The trim 120 has the outlet 140 that is a slit-shaped opening extending along the upper surface 122 of the trim 120. The outlet 140 allows the shoulder belt 132 to be pulled out of the trim 120. The trim 120 has the recesses 220 in the upper surface 122 of the trim 120 at positions adjacent to the outlet 140. The recesses 220 are arranged at intervals in the front-rear direction of the vehicle 100. When the vehicle 100 collides, a portion of the shoulder belt 132 that is in contact with the upper surface 122 of the trim 120 is guided into and retained by one of the recesses 220.

As described above, when the vehicle 100 collides and the occupant moves forward, the position of the shoulder belt 132 in the outlet 140 also moves forward together with the occupant. As a result, there is a possibility that the fastened position of the shoulder belt will be displaced from the appropriate position for the occupant's body size, causing a reduction in the occupant restraint performance of the shoulder belt.

In the vehicle 100 according to the present embodiment, the trim 120 has the recesses 220 in the upper surface 122 of the trim 120 at positions adjacent to the outlet 140. The recesses 220 are arranged at intervals in the front-rear direction of the vehicle 100. Thus, according to the vehicle 100 of the present embodiment, the shoulder belt 132 can be guided into and retained by one of the recesses 220 that is in front of and closest to the shoulder belt 132 when the vehicle 100 collides. Thus, according to the vehicle 100 of the present embodiment, the movement of the shoulder belt 132 in the front-rear direction can be restricted. As a result, the vehicle 100 according to the present embodiment is capable of maintaining the fastened position of the shoulder belt 132 at an appropriate position regardless of the occupant's body size when the vehicle 100 collides. Thus, the vehicle 100 according to the present embodiment is capable of reducing or preventing a reduction in the occupant restraint performance of the shoulder belt 132 when the vehicle 100 collides.

The vehicle 100 according to the present embodiment may further include the lids 230, each of which covers one of the recesses 220. One or more of the lids 230 may open to allow the shoulder belt 132 to be guided into and retained by one of the recesses 220 when the vehicle 100 collides.

Accordingly, in the vehicle 100 according to the present embodiment, the shoulder belt 132 is unlikely to be guided into any of the recess 220 under normal conditions. Thus, according to the vehicle 100 of the present embodiment, the movement of the shoulder belt 132 in the front-rear direction is unlikely to be restricted under normal conditions. As a result, the vehicle 100 according to the present embodiment allows the shoulder belt 132 to move in the front-rear direction under normal conditions, and is capable of maintaining the fastened position of the shoulder belt 132 at an appropriate position regardless of the occupant's body size.

The vehicle 100 according to the present embodiment may further include the pretensioner 150 configured to operate the retractor 136 to retract the shoulder belt 132 when a collision of the vehicle 100 is detected. One of more of the lids 230 may open when the pretensioner 150 is activated.

Thus, according to the vehicle 100 of the present embodiment, when the vehicle 100 collides, the shoulder belt 132 can be appropriately guided into and retained by one of the recesses 220.

The shoulder belt 132 may be positioned above the lids 230 that cover the recesses 220 when the vehicle 100 is not in a collision. When the pretensioner 150 is activated, the shoulder belt 132 retracted by the pretensioner 150 may press one of the lids 230 downward so that a corresponding one of the recesses 220 is exposed.

Thus, according to the vehicle 100 of the present embodiment, it is not necessary to use a dedicated device for opening the lids 230 when the vehicle 100 collides. As a result, in the vehicle 100 according to the present embodiment, the lids 230 can be opened at low cost.

Each of the recesses 220 may be a U-shaped recess having the recess bottom 222 that is offset forward. The turnover member 226 that projects toward the center of the U-shaped recess may be formed on the recess side surface 224 at the front end of the U-shaped recess.

When each recess 220 is the U-shaped recess having the recess bottom 222 that is offset forward, when the shoulder belt 132 is guided into the recess 220, the shoulder belt 132 is unlikely to be unnecessarily folded or jammed in the recess 220. In addition, since the recess 220 has the turnover member 226, the shoulder belt 132 retained by the recess 220 is unlikely to be released from the recess 220.

Although an embodiment of the disclosure has been described with reference to the accompanying drawings, the disclosure is not limited to the above-described embodiment. It is apparent that those skilled in the art can arrive at various alterations and modifications within the scope defined by the claims, and such alterations and modifications also fall within the technical scope of the disclosure.

For example, the structure of the vehicle 100 has been described with reference to FIG. 1. However, some components of the vehicle 100 may be omitted, and the vehicle 100 may include additional components.

In the above-described example, each recess 220 is a U-shaped recess having the recess bottom 222 that is offset forward. However, the shape of each recess 220 is not limited to this.

In the above-described example, the turnover member 226 that projects toward the center of the U-shaped recess is formed on the recess side surface 224 at the front end of the U-shaped recess. However, the turnover member 226 may be omitted.

In the above-described example, each lid 230 is provided with the rotating shaft 232. However, the lid 230 is not limited to this as long as the lid 230 can be opened when the vehicle 100 collides. For example, when the vehicle 100 collides, the shoulder belt 132 retracted by the pretensioner 150 may break one of the lids 230 so that the corresponding one of the recesses 220 is exposed.

In the above-described example, when the pretensioner 150 is activated, the shoulder belt 132 retracted by the pretensioner 150 presses one of the lids 230 downward so that the corresponding one of the recesses 220 is exposed. However, as long as one or more of the lids 230 open when the vehicle 100 collides, it is not necessary that the lids 230 be opened by the shoulder belt 132. For example, the vehicle 100 may further include an actuator capable of opening or breaking the lids 230 when a collision of the vehicle 100 is detected.

In the above-described example, one or more of the lids 230 open when the pretensioner 150 is activated. However, this does not imply any limitation as long as one or more of the lids 230 open when the vehicle 100 collides.

In the above-described example, the vehicle 100 includes the pretensioner 150. However, the pretensioner 150 may be omitted.

In the above-described example, the vehicle 100 includes the lids 230. However, the lids 230 may be omitted.

In the above-described example, the outlet 140 is formed in the upper surface 122 of the trim 120. However, this does not imply any limitation as long as the outlet 140 is formed along the upper surface 122 of the trim 120. For example, when a side pad is provided on the upper surface of the trim 120, a gap between the trim 120 and the side pad may serve as the outlet 140.

According to the disclosure, the reduction in the occupant restraint performance of the shoulder belt during a vehicle collision can be reduced or prevented.

1. A vehicle comprising:
a rear seat;
a trim provided obliquely behind the rear seat;
a shoulder belt for the rear seat; and
a retractor provided in the trim and configured to retract the shoulder belt,
wherein the trim has an outlet that is a slit-shaped opening extending along an upper surface of the trim, the outlet allowing the shoulder belt to be pulled out of the trim,
wherein the trim has recesses in the upper surface of the trim at positions adjacent to the outlet, the recesses being arranged at intervals in a front-rear direction of the vehicle, and
wherein the shoulder belt is configured such that, when the vehicle collides, a portion of the shoulder belt that is in contact with the upper surface of the trim is guided into and retained by one of the recesses.

2. The vehicle according to claim 1, further comprising:
lids covering the recesses respectively,
wherein the vehicle is configured such that one or more of the lids open to allow the shoulder belt to be guided into and retained by one of the recesses when the vehicle collides.

3. The vehicle according to claim 2, further comprising:
a pretensioner configured to operate the retractor to retract the shoulder belt when a collision of the vehicle is detected,
wherein the one or more of the lids open when the pretensioner is activated.

4. The vehicle according to claim 3,
wherein the shoulder belt is positioned above the lids that cover the recesses when the vehicle is not in a collision, and
wherein the shoulder belt is configured such that, when the pretensioner is activated, the shoulder belt retracted by the pretensioner presses one of the lids downward so that a corresponding one of the recesses is exposed.

5. The vehicle according to claim 1,
wherein each of the recesses is a U-shaped recess having a recess bottom that is offset forward, and
wherein a turnover member that projects toward a center of the U-shaped recess is provided on a recess side surface at a front end of the U-shaped recess.

6. The vehicle according to claim 2,
wherein each of the recesses is a U-shaped recess having a recess bottom that is offset forward, and
wherein a turnover member that projects toward a center of the U-shaped recess is provided on a recess side surface at a front end of the U-shaped recess.
